(19) United States
(12) Patent Application Publication
(10) Pub. No.: US 2009/0192784 A1
(43) Pub. Date: Jul. 30, 2009

(54) SYSTEMS AND METHODS FOR ANALYZING ELECTRONIC DOCUMENTS TO DISCOVER NONCOMPLIANCE WITH ESTABLISHED NORMS

(75) Inventors: Kameron Arthur Cole, Dubuque, IA (US); Daniel Frederick Gruhl, San Jose, CA (US); Sreeram Balakrishnan, Los Alto, CA (US); Tetsuya Nasukawa, Kanagawa-Ken (JP)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/019,570

(22) Filed: Jan. 24, 2008

(51) Int. Cl. G06F 17/27; G06F 17/30

(52) U.S. Cl. 704/9; 707/5; 707/E17.014

(57) ABSTRACT

A computer-implemented method for analyzing documents to discover noncompliance with an established norm is provided. The method can include receiving one or more terms indicating possible noncompliance with a pre-established norm, and, based upon the at least one term, constructing at least one grammatical unit. The grammatical unit can specify a predetermined syntax and can correspond to semantic content that is indicative of noncompliance with the pre-established norm, wherein the norm can include a statute, regulation, policy, or other standard. The method can further include identifying from among multiple electronic documents each document that contains one or more grammatical units specifying a predetermined syntax and corresponding to semantic content indicative of noncompliance with the pre-established norm.

### FIELD OF THE INVENTION

The present invention is related to the field of electronic data processing. More particularly, the invention is directed to systemized techniques for analyzing documents to determine possible noncompliance with an established norm, such as a statute, regulation, or policy.

### BACKGROUND OF THE INVENTION

Most, if not all, businesses and other public entities are required to comply with certain legal and ethical norms. The norms can be codified in statutes. The norms can be in the form of regulations administered by regulatory bodies. Moreover, a company or other entity may establish certain policies or practices that the company imposes on its employees.

Statutes and regulations with which companies trading in stocks, bonds, and other financial instruments must comply, for example, are enforced by the US Securities and Exchange Commission (SEC). Thus, SEC-imposed norms typically compel such a company to monitor various forms of documents, both electronic and non-electronic, concerning financial transactions in which the company engages through its employees. This is usually necessary since the company must guarantee to the SEC that its activities are consistent with established statutes and regulations. The company's monitoring of activities generally must be continuous since the SEC can, under certain legally prescribed conditions, instigate an investigation at any time.

In a wide variety of contexts, the extraordinary increase in the use of email has added significantly to the amount of electronic data that a company must monitor on a routine basis. Trading data, and other quantitative-based business data, has been routinely exchanged electronically for many years now. Because such data is non-linguistic in nature, mathematical algorithms can be applied fairly easily to monitor such data exchanges. Owing to the introduction of email and other forms of electronic document and data exchange, however, data that must be monitored is increasingly linguistic in nature.

The capabilities of conventional systems and techniques for monitoring data exchanges are usually not effective or efficient for monitoring such linguistic-based data exchanges. For example, computer programs that monitor email traffic for objectionable terms, such as profanity, are not useful in terms of monitoring compliance with statutory, regulatory, or policy norms. The language used when unethical or illegal business behavior is involved seldom if ever is readily linked to individual words or phrases. To the contrary, in the context of SEC-compliance monitoring, for example, detecting a violation of SEC requirements typically requires analysis of language-embedded semantics. For example, a phrase such as “sell my stock today, but date the sale yesterday,” does not contain any term that would raise suspicion using conventional monitoring techniques, such as those that monitor for single objectionable words. Even a phrase such as “date the sale yesterday” would not necessarily be a cause for concern if in fact the sale occurred yesterday. If it occurred later, however, the phrase would indicate the likely commission of a crime—something only indicated by the conjunction of the phrases “sell my stock today” and “date the sale yesterday.”

A human reader, of course, could ascertain the underlying semantics in such phrases indicating the violation of a regulation or other norm. Indeed, much of data monitoring is typically done by human reader, who usually must scan enormous numbers of emails and other documents to effectively monitor for compliance with established norms. The human reader typically must be specially trained, however, especially since criminal or unethical behavior is not always expressed as obviously as described in these exemplary scenarios. Indeed, communications regarding illicit activity is most likely constructed so as to not be perceived as such by an “uninformed” reader.

Although conventional computer-implemented search tools can be utilized, these tools typically necessitate the construction of complex query strings, whose reliability is only as reliable as the skill of the string's constructor, such as a compliance officer, permits. Moreover, the construction process is typically a tedious, non-iterative process. Accordingly, there is a need for more effective and efficient analytic techniques for analyzing documents to determine whether or not individuals are in compliance with established statutory, regulatory, policy, and other norms.

### SUMMARY OF THE INVENTION

The invention is directed to systems and methods for analyzing documents to discover and identify indicia of actual or suspected noncompliance with an established norm. The established norm can be a statute, regulation, policy, or other such norm.

One embodiment of the invention is a system for analyzing documents to discover noncompliance with an established norm. The system can include a grammatical-unit-constructing module configured to construct, based upon at least one term indicating possible noncompliance with a pre-established norm, at least one grammatical unit that specifies a predetermined syntax and corresponds to semantic content that is indicative of noncompliance with the pre-established norm. The system can further include a document-identifying module configured to identify from among a plurality of electronic documents each document containing the at least one grammatical unit.

A system for analyzing documents to discover noncompliance with an established norm, according to another embodiment, can include a grammatical-unit-constructing module. The grammatical-unit-constructing module can be configured to construct, based upon at least one term indicating possible noncompliance with a pre-established norm, at least one grammatical unit that specifies a predetermined syntax and corresponds to semantic content indicative of noncompliance with the pre-established norm. The system can further include a document-identifying module configured to identify from among a plurality of electronic documents each document containing the at least one grammatical unit.

Yet another embodiment of the invention is a method for analyzing documents to discover noncompliance with an established norm. The method can include receiving at least one term indicating possible noncompliance with a pre-established norm. The method also can include constructing, based upon the at least one term, at least one grammatical unit specifying a predetermined syntax and corresponding to semantic content indicative of noncompliance with the pre-established norm. The method can further include identifying from among a plurality of electronic documents each document containing the at least one grammatical unit.

A method of analyzing documents to discover noncompliance with an established norm, according to still another embodiment of the invention, can include parsing the textual content of each of a plurality of electronic documents, wherein the parsing of textual content generates one or more grammatical units. Additionally, the method can include identifying among the one or more grammatical units at least one term indicative of possible noncompliance with a pre-established norm. The method can further include identifying each electronic document in which the at least one term occurs and has a predetermined grammatical relationship with at least one other term occurring in the same document.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of an exemplary, computer-based environment in which a system for analyzing documents to discover and identify indicia of actual or suspected noncompliance with an established norm, according to one embodiment of the invention, is utilized.

FIG. 2 is a schematic view of one embodiment of the system illustrated in FIG. 1.

FIG. 3 is a schematic view of certain operative features performed, according to one embodiment of the invention, by the system illustrated in FIG. 1.

FIG. 4 is a schematic view of certain other operative features performed, according to one embodiment of the invention, by the system illustrated in FIG. 1.

FIG. 5 is a schematic view of another embodiment of the system illustrated in FIG. 1.

FIG. 6 is a flowchart of exemplary steps in a method for analyzing documents to discover and identify indicia of actual or suspected noncompliance with an established norm, according still another embodiment of the invention.

FIG. 7 is a flowchart of exemplary steps in a method for analyzing documents to discover and identify indicia of actual or suspected noncompliance with an established norm, according to yet another embodiment of the invention.

### DETAILED DESCRIPTION

The invention is directed to systems and methods for analyzing documents to discover and identify indicia of actual or suspected noncompliance with statutory, regulatory, policy, and other norms. Among the possible advantages provided by the systems and methods is the identification of a sender or receiver of a suspicious document, email, or other message. As described herein, the identification can be based upon the inclusion of predefined terms within, for example, communication logs.

Another possible advantage is the identification of periods of suspicious activities based on the distribution of such terms. Yet another possible advantage is the identification of suspicious phrases or clauses within exchanged documents, which according to one embodiment can be based on a probability distribution (e.g., a normal distribution) of content words contained in or obtained from a target set of documents. Still another possible advantage is the enabling of investigation of suspicious phrases and clauses based on computer-implemented analysis of phrasal patterns, such as consecutive adjective-noun patterns comprising at least one term indicating the possible noncompliance with an established statute, regulation, policy, or other norm.

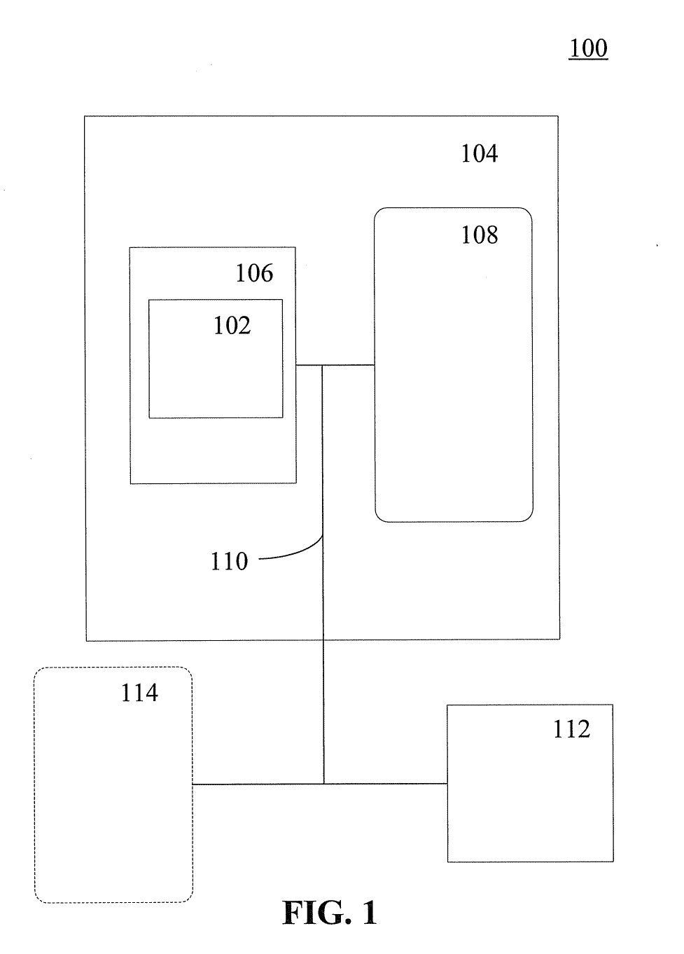

FIG. 1 is a schematic view of an exemplary, operative environment 100 in which a system 102, according to one embodiment of the invention, can be utilized. The operative environment 100 illustratively includes a computing device 104 having one or more processors 106 and electronic memory 108 communicatively linked to one another via a bus 110. The computing device 104 can be a general-purpose or application-specific computer. The one or more processors 106 can comprise logic gates, registers, and other logic-based processing circuitry (not explicitly shown). The memory 108 can electronically store electronic data and processor-executable code or instructions that, when loaded to and executed by the one or more processors 106, cause the one or more processors to process stored electronic data. The operative environment 100 also illustratively includes at least one input/output device 112 for receiving user-supplied input and supplying to the user computer-generated output. Optionally, the operative environment can also include secondary memory 114.

Accordingly, the system 102 can comprise processor-executable code for causing the one or more processors 106 to perform the procedures and functions, described herein, for analyzing documents to discover and identify indicia of actual or suspected noncompliance with one or more established norms. In an alternative embodiment, however, the system 102 can be implemented in dedicated hardwired circuitry for effecting the same procedures and functions. In still another embodiment, the system 102 can be implemented in a combination of processor-executable code and dedicated hardwired circuitry.

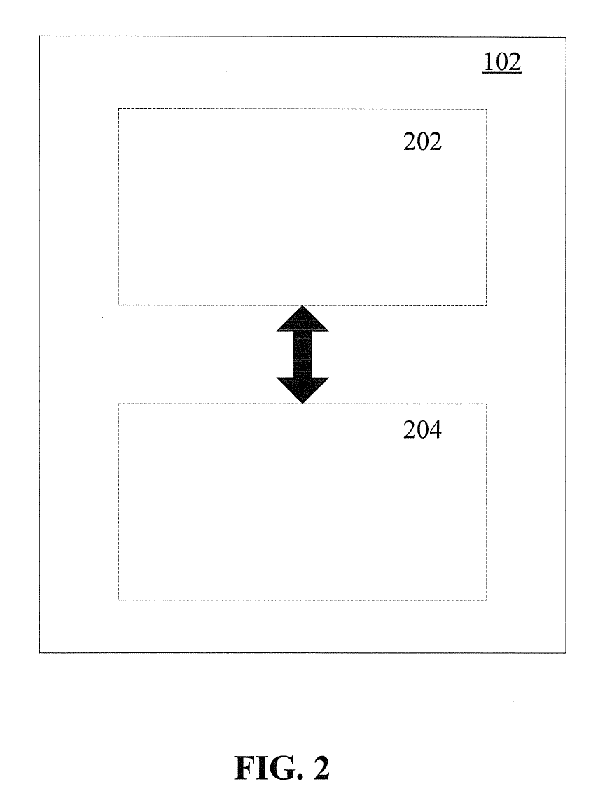

Referring additionally now to FIG. 2, one embodiment of the system 102 is schematically illustrated. The system 102 illustratively includes a grammatical-unit-constructing module 202 and a document-identifying module 204 that cooperatively execute on the one or more processors 106. The grammatical-unit-constructing module 202 is configured to construct, based upon at least one term indicating possible noncompliance with a pre-established norm, at least one grammatical unit.

As used herein, a grammatical unit is a set of words which form a conceptual whole, or denote a complete concept, in that each of the words in the grammatical unit has a direct, definable relation to each other word in the grammatical unit. Accordingly, a grammatical unit is, according to the invention, able to distinguish a relationally-linked group of words from a locationally-linked group of words. For example, in the sentence “I shot an elephant in my pajamas,” although the word elephant is located close to the word in, elephant does not have a grammatical relation to in. Rather, the word in has a grammatical relation to the subject, I. The grammatical unit thus allows analytics to apply to other languages, which are morphological, rather than syntactic, as well. The present invention uses this notion of a grammatical unit and applies it to textual analysis. In this way, the present invention disambiguates searches. Other search engines return erroneous matches, based only on syntactic proximity. With respect to eDiscovery, for example, there is a need to match meanings accurately. This is only possible through application of the type of analytics provided by the invention, as described herein.

The one or more grammatical units so constructed by the grammatical-unit-constructing module 202 each specifies a predetermined syntax and correspond to semantic content indicative of noncompliance with the pre-established norm. The document-identifying module 204 is configured to identify from among a plurality of electronic documents each document containing the at least one grammatical unit.

Operatively, the system 102 according to this embodiment provides a bottom-up approach for analyzing documents to discover and identify indicia of actual or suspected noncompliance with statutory, regulatory, policy, and other norms. Such an approach can be utilized, for example, when an individual such as a compliance officer has a suspicion concerning a particular individual and/or a particular activity—perhaps isolated to a particular time period—in connection with the noncompliance of an established norm, such as an SEC regulation. The individual thus knows what information is sought, but does not know where within a large corpus of electronic documents, such as emails, the information can be found.

As an initial matter a tool such as OminFind Analytics Edition™ (OAE) provided by International Business Machines Corporation (IBM) of Armonk, N.Y., can be utilized. OAE is based on the open Unstructured Information Management Architecture (UIMA) standard and can filter the corpus of documents so as to identify those documents that contain one or more specified terms. Thus, from a particular corpus of documents, filtering based upon supplied terms culls from the corpus only those that include one or more of the terms.

The grammatical-unit-constructing module 202 is needed, however, to syntactically construct from the terms those grammatical units that provide patterns and/or rules such that specific semantic content can be readily mined from the corpus. For example, synonymous terms can be paired, according to one embodiment. Additionally, or alternately, semantically equivalent syntactic constructs can be determined. For example, in the earlier-described context of identifying noncompliance with SEC regulations, the phrase “sell my stock today, but date the sale yesterday” can be determined to be semantically equivalent to the alternative phrases “date the sale yesterday, but sell my stock today” and “pre-date the sale of yesterday's stock purchase,” as well as other such phrases.

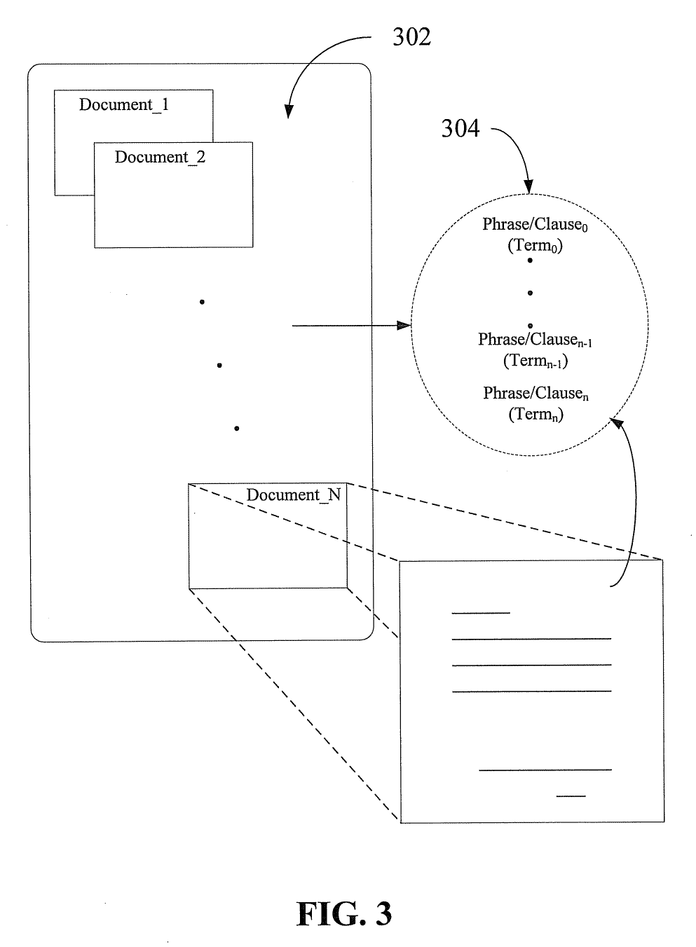

FIG. 3 schematically illustrates certain of these operative features. For a plurality of N documents 302 (Document_1, Document_2, . . . , Document_N) a plurality of grammatical units 304 are generated by the grammatical-unit-constructing module 202. Illustratively, the grammatical units 304 comprise phrases and/or clauses (Phrase/Clause₀, . . . , Phrase/Clauseₙ₋₁, Phrase/Clauseₙ) each comprising one or more previously-identified terms (Term₀, . . . , Termₙ₋₁, Termₙ). Thus, each of the grammatical units 304 can comprise the at least one term and at least one additional term, each term being synonymous with the other. Alternatively, or additionally, each of the grammatical units 304 can be semantically related to one another.

The terms that are employed in generating the grammatical units 304 can change, the grammatical units possibly changing accordingly, as the procedure is repeated. A compliance officer or other user can change the terms at will, adding or deleting terms, as the users understanding of the particular case being examined improves. In another embodiment, the terms can be changed based on known techniques of artificial intelligence, machine learning, and/or neural network computing, which the system can be further configured to implement automatically.

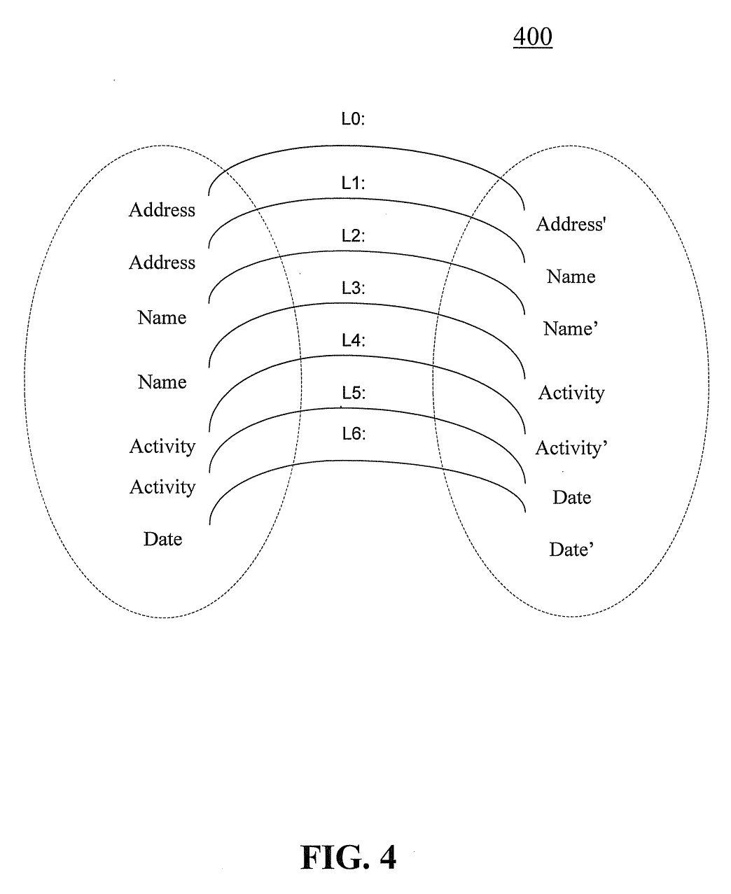

The grammatical-unit-constructing module 202, according to still another embodiment, can be configured to link different words, phrases, and clauses. For example, as schematically illustrated in FIG. 4, different rules or patterns can be constructed to provide links (L). Addresses (e.g., email addresses) can be linked to other addresses (L0). Addresses can be linked to names (L1) (e.g., email address to name). Names can be linked to other names (L2). Names can be linked to activities (L3) (e.g., names to trading activities). Activities can be linked to other activities (L4). Activities can be linked to dates (L5), and dates can be linked to other dates (L6). Thus, for example, again in the exemplary context of SEC compliance monitoring. Names of key company executives can be linked to stock sales. Moreover, because the user can specify any type of date restriction, sales of stock by certain individuals just before an adverse press release can be readily identified from certain electronic documents analyzed using the system 102.

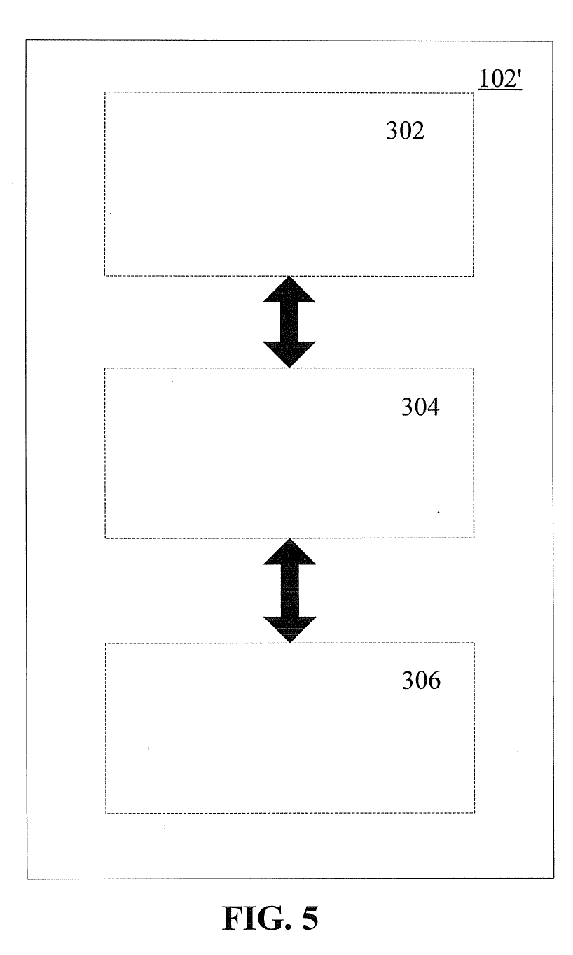

FIG. 5 is a schematic view of a system 102′ for analyzing documents to discover noncompliance with an established norm, according to another embodiment. Again, the system 102′ can be implemented in processor-executable code and/or dedicated hardwired circuitry. Illustratively, the system 102′ includes a parsing module 302, a term-identifying module 304, and a document-identifying module 306 that cooperatively perform the procedures and functions described hereinafter.

Operatively, the parsing module 302 is configured to parse into one or more grammatical units the textual content of each electronic document belonging to a set of electronic documents. The term-identifying module 304 is operatively configured to identify among the one or more grammatical units at least one suspect term indicative of possible noncompliance with a pre-established norm. The document-identifying module 306 is operatively configured to identify among the set of electronic documents each electronic document in which the at least one suspect term occurs and has a predetermined grammatical relationship with at least one other suspect term occurring in the same document.

The system 102′ is configured to perform a top-down analysis of documents. Accordingly, it can be utilized by a compliance officer or other user who is “in the dark” about whether or not noncompliance with an established norm has occurred or may occur in the future. For example, an antitrust violation may have been reported against a company, but the origins and circumstances of the violation are as yet unknown. Alternatively, the compliance officer or other user may be tasked with examining various electronic documents, such as a collection of emails, so as to identify any suspicious communications or activities without any preconceived suspicion of noncompliance activities. In one sense, the system 102′ can be viewed as providing a mechanism for reverse-engineering the term lists described in the context of a bottom-up analysis.

Initially, the system 102′ examines the results of grammatical parsing that can be effected, for example, with OAE. Accordingly, the compliance officer or other user can identify all grammatical elements (nouns, verbs, adjectives, etc.). One element or term may appear suspicious, either because it seems odd in the particular context (e.g., stock trading), or because it occurs with unusual frequency in a corpus of documents. The latter determination can be based on various known statistical techniques: Such suspect terms can be iteratively joined using the system 102′ so as to dynamically construct a search query. A term can be analyzed with the system 102′ in its grammatical and/or semantic relationship with one or more other terms. For example, in the corpus of documents, the term “trade” may occur with an inordinately high frequency; this is not in itself unusual in certain contexts. However, a high occurrence of “trade” with “unfair” would be revealed by the system 102′ as suspect.

The system 102′ can reduce the number of suspect documents by eliminating from the set of examined documents all documents save those in which suspicious terms occur in a specific grammatical relationship (e.g., adjective . . . noun). The significance of the grammatical relationship, again, can be illustrated in the context of monitoring for SEC violations. Terms “trade” and “unfair” can co-occur in a document, but without a grammatical relationship indicating any suspicious activity. For example, a document might state the following: “The rules in professional league baseball have become unfair to the players, so I'm trading in my mitt for an umpire's hat.” Although conventional search engines would return this result, along with “unfair trading,” with the same relevancy score. Doing so, however, at best is inefficient. At worst it can be misleading, possibly yielding an enormous number of irrelevant documents. The problem is solved by eliminating any documents that, though containing suspect terms, do not present the terms in a grammatical relationship such that the semantics of the documents' phrases and/or clauses warrant suspicion.

Accordingly, the system 102′ can further comprise a set-reduction module configured to reduce the set electronic documents by eliminating from the set each document not containing at least one suspect term in the predetermined grammatical relationship with at least one other suspect term. Moreover, the system 102′ can reveal larger patterns, which are suggested by certain grammatical units constructed. For example, the term “trade” can evolve into “policies at Company X . . . create imbalance . . . for outside investments . . . may . . . result in . . . unfair trading practice.” Thus, the compliance officer or other user of the system 102′ has learned about the possibility of unfair trading at Company X, as a result of the revealed policy. That is, it is not a case of actual unfair trading, but rather a prediction that unfair trading may well occur in the future. Thus, the system 102′ can “teach” the compliance officer or other user, over repeated iterations, to identify possible noncompliance even where no suspicion previously existed. The analysis can be then be run against another, larger set of documents to corroborate or mitigate suspicions.

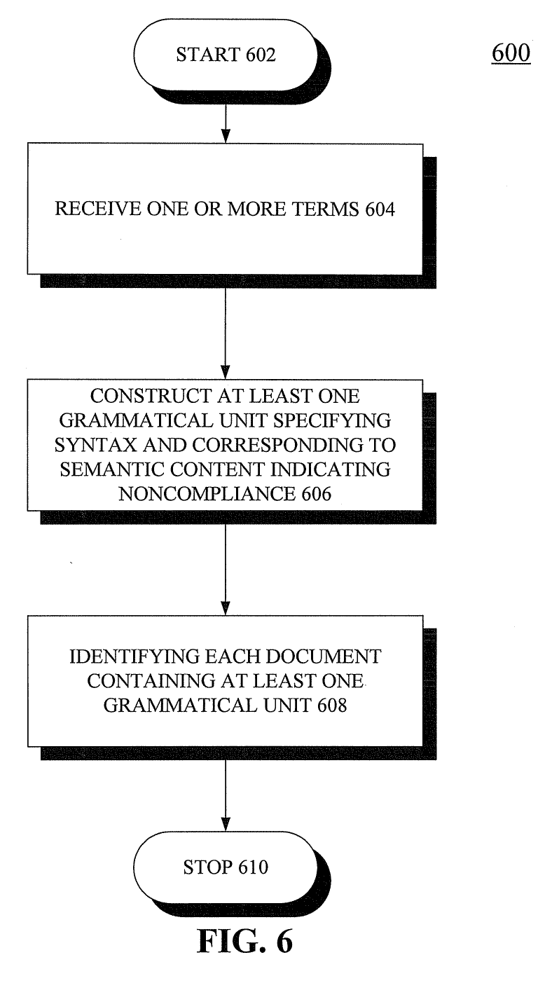

FIG. 6 illustrates one methodological aspect of the invention, providing a flowchart of exemplary steps in a method 600 for analyzing documents to discover and identify indicia of actual or suspected noncompliance with an established norm according still another embodiment of the invention. The method 600, after the start at step 602, includes receiving at least one term indicating possible noncompliance with a pre-established norm at step 604. The method 600 farther includes, at step 606, constructing at least one grammatical unit specifying a predetermined syntax and corresponding to semantic content indicative of noncompliance with the pre-established norm, the construction being based upon the at least one term. At step 608, the method 600 includes identifying from among a plurality of electronic documents each document containing the at least one grammatical unit. The method 600 illustratively concludes at 610.

According to one embodiment, the step 606 of constructing at least one grammatical unit can comprise constructing a plurality of grammatical units comprising the at least one term and at least one additional term, each term being synonymous with the other. According to another embodiment, the step 606 of constructing at least one grammatical unit can comprise constructing a plurality of grammatical units comprising the at least one term, wherein the plurality of grammatical units are semantically related to one another. According to still another embodiment, the step 606 of constructing at least one grammatical unit can comprise linking at least one among a name, an address, and an activity with at least one among another name, another address, and another activity.

Optionally, the method 600 can further include identifying from among the plurality of electronic documents each document associated with a predetermined date. Additionally, or alternatively, the method 600 can further include identifying from among the plurality of electronic documents each document associated with a predetermined range of times for the predetermined date. According to yet another embodiment, the method 600 additionally or alternatively can include repeating the constructing and identifying steps based upon at least one additional term indicating possible noncompliance with a pre-established norm.

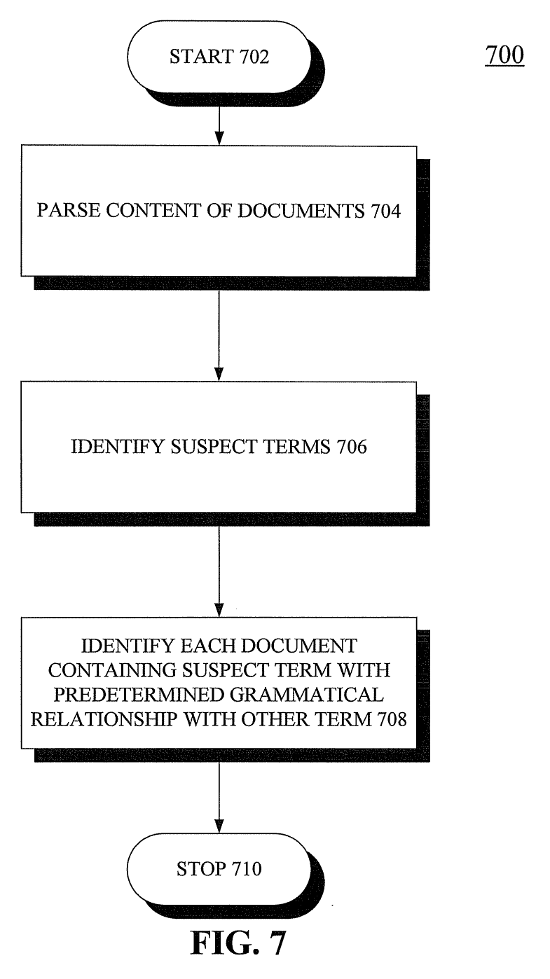

FIG. 7 is flowchart of exemplary steps in a method 700 for analyzing documents to discover and identify indicia of actual or suspected noncompliance with an established norm, according to yet another embodiment of the invention. The method 700, after the start at step 702, illustratively includes parsing textual content of each electronic document in a set of electronic documents at step 704, the parsing yielding for each electronic document one or more grammatical units. The method 700 further includes identifying among the one or more grammatical units at least one suspect term indicative of possible noncompliance with a pre-established norm at step 706. Additionally, at step 708, the method 700 includes identifying each electronic document in which the at least one suspect term occurs and has a predetermined grammatical relationship with at least one other suspect term occurring in the same document. The method illustratively concludes at step 710.

The method 700, according to another embodiment, can further include dynamically building a search query by iteratively repeating the term and document identifying steps and successively adding additional suspect terms. According to still another embodiment, the method 700 also can include dynamically building a search query by iteratively repeating the term and document identifying steps and successively deleting suspect terms from the search query. The method 700, according to yet another embodiment, can include reducing the set electronic documents by eliminating from the set each document not containing the at least one suspect term in the predetermined grammatical relationship with the at least one other suspect term.

According to another embodiment, the step 706 of identifying the at least one suspect term can comprise identifying a term occurring in one or more of the electronic documents with a frequency that exceeds a predetermined number. The predetermined number, moreover, can be based upon a pre-established probability function.

The method 700, according to yet another embodiment, can further include predicting with a predetermined probability the likelihood of a noncompliant activity occurring. According to still another embodiment, the method 700 can further include dynamically building a search query by iteratively repeating the term and document identifying steps and subsequently applying the search query to a set of related electronic documents to corroborate or eliminate a predetermined likelihood that a noncompliant activity has occurred.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for analyzing documents to discover noncompliance with an established norm, the method comprising:
receiving at least one term indicating possible noncompliance with a pre-established norm;
based upon the at least one term, constructing at least one grammatical unit specifying a predetermined syntax and corresponding to semantic content indicative of noncompliance with the pre-established norm; and
identifying from among a plurality of electronic documents each document containing the at least one grammatical unit.

2. The method of claim 1, wherein the step of constructing at least one grammatical unit comprises constructing a plurality of grammatical units, each grammatical unit comprising the at least one term and at least one additional term that is synonymous with the at least one term.

3. The method of claim 1, wherein the step of constructing at least one grammatical unit comprises constructing a plurality of grammatical units that are semantically related to one another.

4. The method of claim 1, wherein the step of constructing at least one grammatical unit comprises linking at least one among a name, an address, and an activity with at least one among another name, another address, and another activity.

5. The method of claim 1, further comprising identifying from among the plurality of electronic documents each document associated with a predetermined date.

6. The method of claim 5, further comprising identifying from among the plurality of electronic documents each document associated with a predetermined range of times for the predetermined date.

7. The method of claim 1, further comprising repeating the constructing and identifying steps based upon at least one additional term indicating possible noncompliance with a pre-established norm.

8. A computer-implemented method of analyzing documents to discover noncompliance with an established norm, the method comprising:
for a set comprising more than one electronic document, parsing textual content of each electronic document into one or more grammatical units;
identifying among the one or more grammatical units at least one term indicative of possible noncompliance with a pre-established norm; and
identifying each electronic document in which the at least one term occurs and has a predetermined grammatical relationship with at least one other term occurring in the same document.

9. The method of claim 8, further comprising dynamically building a search query by iteratively repeating the term and document identifying steps and successively adding additional terms.

10. The method of claim 9, further comprising dynamically building a search query by deleting at least one term from the search query.

11. The method of claim 8, further comprising reducing the set comprising electronic documents by eliminating from the set each document not containing the at least one term in the predetermined grammatical relationship with the at least one other term.

12. The method of claim 8, wherein the step of identifying at least one term comprises identifying a term occurring in one or more of the electronic documents with a frequency that exceeds a predetermined number.

13. The method of claim 12, wherein the predetermined number is based upon a pre-determined probability function.

14. The method of claim 8, further comprising predicting according to a predetermined probability distribution the likelihood of a noncompliant activity occurring.

15. The method of claim 8, further comprising dynamically building a search query by iteratively repeating the term and document identifying steps and successively adding additional terms, and subsequently, applying the search query to a set of related electronic documents to corroborate or eliminate a predetermined likelihood that a noncompliant activity has occurred.

16. A system for analyzing documents to discover noncompliance with an established norm, the system comprising:
a grammatical-unit-constructing module configured to construct, based upon at least one term indicating possible noncompliance with a pre-established norm, at least one grammatical unit specifying a predetermined syntax and corresponding to semantic content indicative of noncompliance with the pre-established norm; and
a document-identifying module configured to identify from among a plurality of electronic documents each document containing the at least one grammatical unit.

17. The system of claim 16, wherein the at least one grammatical unit comprises a plurality of grammatical units, and wherein the grammatical-unit-constructing module is configured to construct the plurality of grammatical units such that each of the grammatical units comprises the at least one term and at least one additional term, each term being synonymous with the other.

18. The system of claim 16, wherein the at least one grammatical unit comprises a plurality of grammatical units, and wherein the grammatical-unit-constructing module is configured to construct the plurality of grammatical units such that the plurality of grammatical units are semantically related to one another.

19. A system for analyzing documents to discover noncompliance with an established norm, the system comprising:
a parsing module configured to parse into one or more grammatical units textual content of each electronic document belonging to a set of electronic documents;
a term-identifying module configured to identify among the one or more grammatical units at least one term indicative of possible noncompliance with a pre-established norm; and
a document-identifying module configured to identify among the set of electronic documents each electronic document in which the at least one term occurs and has a predetermined grammatical relationship with at least one other term occurring in the same document.

20. The system of claim 19, further comprising a set-reduction module configured to reduce the set electronic documents by eliminating from the set each document not containing the at least one term in the predetermined grammatical relationship with the at least one other term.
